(19) United States
(12) Patent Application Publication
(10) Pub. No.: US 2015/0077632 A1
(43) Pub. Date: Mar. 19, 2015

(54) DISPLAY DEVICE AND DISPLAY METHOD

(71) Applicant: HON HAI PRECISION INDUSTRY CO., LTD., New Taipei (TW)

(72) Inventors: CHENG-CHUNG WU, New Taipei (TW); SHIH-YANG YANG, New Taipei (TW)

(21) Appl. No.: 14/484,555

(22) Filed: Sep. 12, 2014

(30) Foreign Application Priority Data
Sep. 13, 2013 (TW) 102133114

(51) Int. Cl. H04N 7/01; G09G 3/36; G09G 5/00; H04N 5/44

(52) U.S. Cl. CPC H04N 7/0117; H04N 5/44; G09G 3/36; G09G 5/006; G09G 5/005; G09G 2370/16
USPC 348/445; 348/725; 348/730

(57) ABSTRACT

A display device is associated with a device ID. The display device includes a multi-media board, a drive board, and a liquid crystal display (LCD) panel. The display device is connected to a video source via a wireless high-definition (WiHD) network, and receives a target ID from the video source. When the target ID matches the device ID, the multi-media board receives video data from the video source, and transmits the video data to the drive board. The drive board generates drive signals based on the video data, and transmits the drive signals to the LCD panel. The LCD panel presents video images according to the drive signals. A display method is also disclosed.

### CROSS-REFERENCE TO RELATED APPLICATIONS

This application claims priority to Taiwanese Patent Application No. 102133114 filed on Sep. 13, 2013 in the Taiwan Intellectual Property Office, the contents of which are hereby incorporated by reference. Relevant subject matter is disclosed in co-pending U.S. patent applications entitled “DISPLAY DEVICE”, Attorney Docket Number US52297, U.S. application Ser. No. [to be advised], filed on the same day as the present application, and co-pending U.S. patent applications entitled “DISPLAY DEVICE”, Attorney Docket Number US52298, U.S. application Ser. No. [to be advised], filed on the same day as the present application.

### FIELD

The disclosure generally relates to display devices, and more particularly relates to display devices including a liquid crystal display (LCD) panel and display methods implemented by the same.

### BACKGROUND

Display devices are output devices for presentation of information in visual form. The display devices are commonly used as screens for a wide variety of electronic devices, such as televisions and computers.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a block diagram of an embodiment of a display device communicating with a video source.

FIG. 2 is a block diagram of an embodiment of a plurality of display devices communicating with the video source.

FIG. 3 is a flowchart of an embodiment of a display method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein. It should be noted that references to “an” or “one” embodiment in this disclosure are not necessarily to the same embodiment, and such references can mean “at least one.”

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

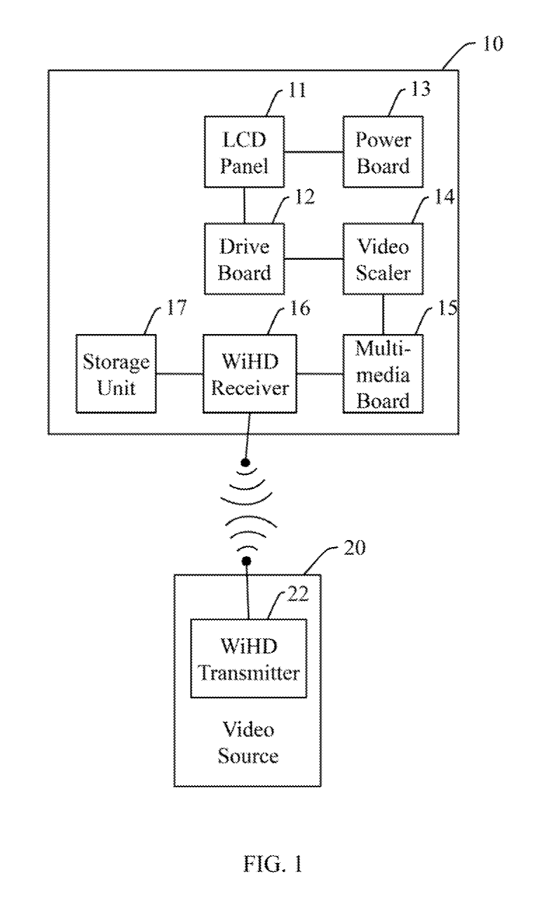

FIG. 1 illustrates a block diagram of an embodiment of a display device 10. The display device 10 includes an LCD panel 11, a drive board 12, a power board 13, a video scaler 14, a multi-media board 15, a wireless high-definition (WiHD) receiver 16, and a storage unit 17. The display device 10 can receive video data from a video source 20, and present video images corresponding to the video data. The video source 20 includes a WiHD transmitter 22. The video source 20 can be a television, a computer, a digital video disc (DVD) player, a gaming device, a smart phone, or any other electronic device.

The storage unit 17 can store a device identifier (ID) of the display device 10. The device ID can include one or more numbers, letters, or symbols.

The WiHD receiver 16 can establish a wireless connection with the WiHD transmitter 22, and the video source 20 can transmit the video data to the display device 10 via the wireless connection. WiHD is a unified standard which defines a specification for a digital network interface for wireless transmission of high-definition content for consumer electronics products.

The video source 20 can transmit a target ID to the WiHD receiver 16 after the wireless connection is established. The WiHD receiver 16 can retrieve the device ID from the storage unit 17 and compare the device ID with the target ID. When the device ID matches the target ID, the multi-media board 15 can receive video data from the video source 20 via the wireless connection. The multi-media board 15 is connected to the video scaler 14 and can transmit the video data to the video scaler 14.

The video scaler 14 can scale the video data and generate scaled video data of a dimension compatible with the LCD panel 11. The video scaler 14 can scale the video data in either the horizontal or the vertical direction. The video scaler 14 is connected to the drive board 12, and can transmit the scaled video data to the drive board 12.

The drive board 12 can generate drive signals based on the scaled video data. The drive board 12 is connected to the LCD panel 11, and can transmit the drive signals to the LCD panel 11.

The power board 13 can provide power to the LCD panel 11. The LCD panel 11 can present video images according to the drive signals received from the drive board 12.

The drive board 12 and the LCD panel 11 communicate with each other via a high-speed signal transmission interface.

When a resolution of the LCD panel 11 is lower than the Full HD resolution (1920*1080 pixels), the drive board 12 can transmit the drive signals to the LCD panel via a low voltage differential signaling (LVDS) interface. The LVDS interface can operate at low power and can run at very high speeds using inexpensive twisted-pair copper cables.

When the resolution of the LCD panel 11 is equal to or higher than the Full HD resolution, the drive board 12 can transmit the drive signals to the LCD panel via a V-by-One HS interface. The V-by-One HS interface can run at faster speeds than the LVDS interface.

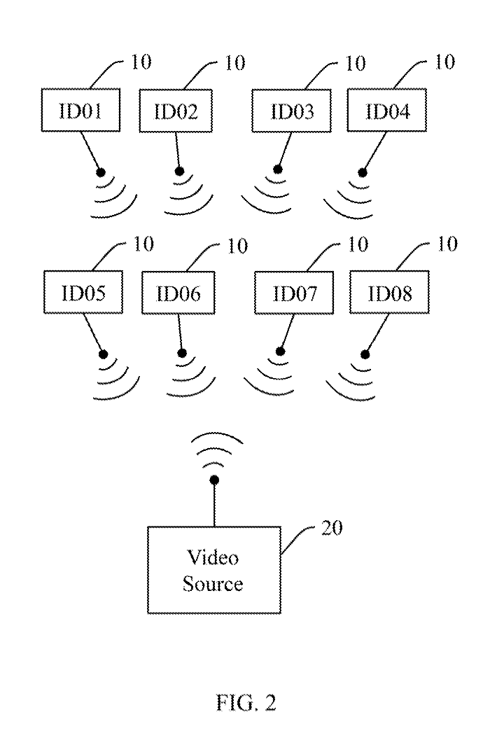

FIG. 2 illustrates a block diagram of an embodiment of a plurality of display devices 10 arranged in a matrix. Each of the display devices 10 has a unique device ID, such as ID01, ID02, ID03, and so on. When the video source 20 has established a wireless connection with the display devices 10, the video source 20 can transmit a target ID to the display devices 10 to select a specific one of the display devices 10 and transmit video data to the selected display device 10.

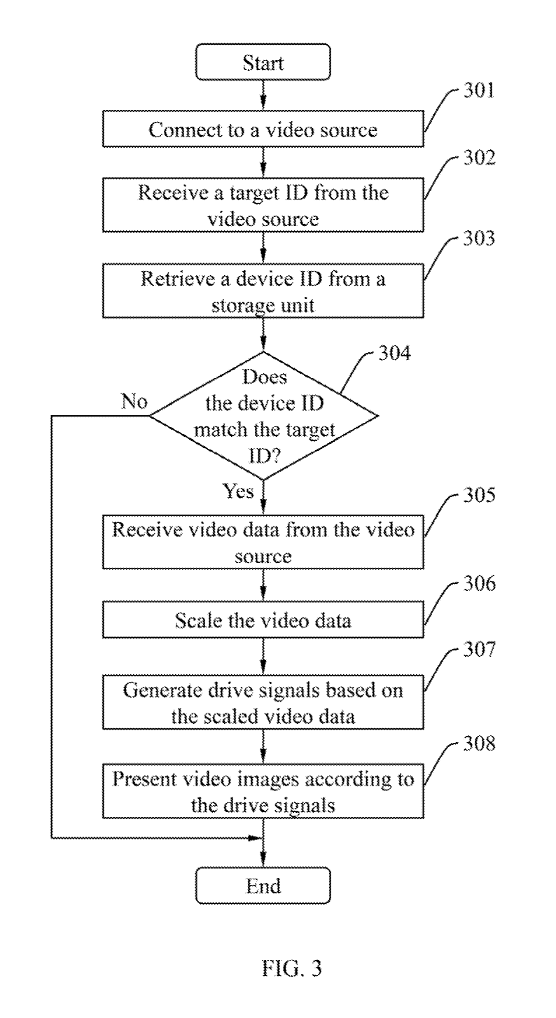

FIG. 3 illustrates a flowchart of an embodiment of a display method. The display method is provided by way of example, as there are a variety of ways to carry out the method. The method described below can be carried out using the configurations illustrated in FIGS. 1 and 2, for example, and various elements of these figures are referenced in explaining example method. Each block shown in FIG. 3 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block 301.

In block 301, a WiHD receiver 16 establishes a wireless connection with a WiHD transmitter 22 of a video source 20.

In block 302, the WiHD receiver 16 receives a target ID from the video source 20 via the wireless connection.

In block 303, the WiHD receiver 16 retrieves a device ID from a storage unit 17.

In block 304, the WiHD receiver 16 compares the device ID with the target ID. If the device ID matches the target ID, block 305 is implemented. Otherwise, the process ends.

In block 305, a multi-media board 15 receives video data from the video source 20 and transmits the video data to a video scaler 14.

In block 306, the video scaler 14 scales the video data and generates scaled video data of a dimension compatible with an LCD panel 11. The video scaler 14 transmits the scaled video data to a drive board 12.

In block 307, the drive board 12 generates drive signals based on the scaled video data and transmits the drive signals to the LCD panel 11.

In block 308, the LCD panel 11 presents video images according to the drive signals received from the drive board 12.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments.

What is claimed is:

1. A display device comprising:
a storage unit configured to store a device identifier (ID) for identifying the display device;
a wireless high-definition (WiHD) receiver configured to establish a wireless connection with a video source and receive a target ID from the video source, the wireless WiHD receiver further configured to retrieve the device ID from the storage unit and determine whether the device ID matches the target ID;
a multi-media board coupled to the wireless receiver;
a drive board coupled to the multi-media board; and
a liquid crystal display (LCD) panel coupled to the drive board,
wherein the multi-media board is configured to receive video data from the video source via the wireless connection and transmit the video data to the drive board, the drive board is configured to generate drive signals based on the video data and transmit the drive signals to the LCD panel, and the LCD panel is configured to present video images according to the drive signals, upon determination that the device ID matches the target ID.

2. The display device of claim 1, further comprising a video scaler housed configured to scale the video data and generate scaled video data of a dimension compatible with the LCD panel and transmit the scaled video data to the drive board, wherein the drive board is configured to generate the drive signals based on the scaled video data.

3. The display device of claim 1, further comprising a power board configured to provide power to the LCD panel.

4. The display device of claim 1, wherein the drive board is configured to transmit the drive signals to the LCD panel via a low voltage differential signaling (LVDS) interface.

5. The display device of claim 1, wherein the drive board is configured to transmit the drive signals to the LCD panel via a V-by-One HS interface.

6. A display system comprising:
a plurality of display devices, each display device associated with a device identifier (ID); and
a video source coupled to the plurality of display devices and configured to transmit a target ID to the plurality of display devices;
wherein when a device ID of a display device matches the target ID, the video source is configured to transmit video data to the display device, the display device is configured to present video images corresponding to the video data.

7. The display system of claim 6, wherein each display device comprises a storage unit for storing a device ID for identifying the display device.

8. The display system of claim 6, wherein the video source is connected to the plurality of display devices via a wireless high-definition (WiHD) network.

9. The display system of claim 6, wherein each display device comprises a liquid crystal display (LCD) panel and a drive board, the drive board is configured to generate drive signals based on the video data and transmit the drive signals to the LCD panel, and the LCD panel is configured to present video images according to the drive signals.

10. The display system of claim 9, wherein each display device comprises a video scaler configured to scale the video data and generate scaled video data of a dimension compatible with the LCD panel and transmit the scaled video data to the drive board, wherein the drive board is configured to generate the drive signals based on the scaled video data.

11. The display device of claim 9, wherein the drive board is configured to transmit the drive signals to the LCD panel via a low voltage differential signaling (LVDS) interface.

12. The display device of claim 9, wherein the drive board is configured to transmit the drive signals to the LCD panel via a V-by-One HS interface.

13. A display method comprising:
connecting to a video source;
receiving a target ID from the video source;
retrieving a device ID from a storage unit;
determining whether the device ID matches the target ID;
when the device ID matches the target ID, receiving video data from the video source and transmitting the video data to a drive board by a multi-media board;
generating drive signals based on the video source and transmitting the drive signals to a liquid crystal display (LCD) panel by the drive board; and
presenting video images according to the drive signals by the LCD panel.

14. The display method of claim 13, further comprising:
connecting to the video source via a wireless high-definition (WiHD) network.

15. The display method of claim 13, further comprising:
scaling the video data and generating scaled video data of a dimension compatible with the LCD panel and transmitting the scaled video data to the drive board by a video scaler; and
generating the drive signals based on the scaled video data.
